(19) United States
(12) Patent Application Publication
(10) Pub. No.: US 2024/0095796 A1
(43) Pub. Date: Mar. 21, 2024

(54) SYSTEM AND METHOD OF ANONYMISING ONLINE INTERACTIONS AND TRANSACTIONS

(71) Applicant: Jasmin ALEKNAVICIUS, Bonville (AU)

(72) Inventor: Jasmin ALEKNAVICIUS, Bonville (AU)

(21) Appl. No.: 18/276,001

(22) PCT Filed: Feb. 7, 2022
(86) PCT No.: PCT/AU2022/050063

§ 371 Date: Aug. 4, 2023

(30) Foreign Application Priority Data
Feb. 5, 2021 (AU) 2021900271

(51) Int. Cl. G06Q 30/0601; G06F 21/31; G06Q 10/083; G06Q 20/02; G06Q 20/12; G06Q 20/38; G06Q 20/40

(52) U.S. Cl. CPC G06Q 30/0615; G06F 21/31; G06Q 10/083; G06Q 20/02; G06Q 20/12; G06Q 20/383; G06Q 20/4037; G06Q 20/3223

(57) ABSTRACT

The present invention provides a hosting system that hosts a plurality of computer executable applications wherein the applications are accessible by a plurality of users registered to use the hosted plurality of applications, the hosting system including a user access module enabling individual users to access the hosting system using personal credentials and upon entering valid personal credentials, users are assigned one or more system personas for use when the user executes a hosted application, where the details of the system persona are used in place of the user's personal details when the hosted application accesses any online service external to the hosting system, a purchasing facility enabling registered users to purchase goods and/or services online with funds managed by the hosting system, the users utilising a system persona when accessing external online services and the hosting system effecting financial transactions for and on behalf of registered users thereby retaining the privacy of user's personal details within the hosting system and avoiding divulging user's personal details to any online system external to the hosting system.

### FIELD OF THE INVENTION

The present invention provides a system and method enabling individuals to avoid disclosing their personal information when engaging with online systems for the purpose of conducting transactions and/or interacting with online sources of information by use of an intermediary system that provides individuals with the ability to control the dissemination of their personal data.

### BACKGROUND OF THE INVENTION

The development of data communications networks and devices that operate by transmitting data across those networks has given rise to many advantages. For example, individuals and consumers now have access to significantly more information than ever before which enables those individuals and consumers to inform themselves by obtaining information directly rather than relying upon limited forms of mass communication which occurred for many decades until the recent developments in data communication networks and computing devices.

Whilst advances in data communication networks were understood to be beneficial, it was the development of the internet that provided a common, accessible and widespread network that significantly advanced the ability of individuals and consumers to obtain and access information from a wide range of sources that were connected to the data communications network known as the internet.

Whilst the internet provided a basic data communication infrastructure over which communications may occur, it was not until the development of the World Wide Web (WWW) that a relatively uniform interface was made available to all users such that they could execute a browser application on their computing platform and access the World Wide Web to seek and obtain information in a reasonably consistent format. Development of the World Wide Web interface was an extremely useful development and commenced the transition of business operations onto online platforms such that individuals and consumers could engage with businesses without the requirement to visit and/or attend a physical premises operated by the business. Over time, businesses increasingly developed an online presence with a web-site accessible by individuals and consumers for the purpose of researching and purchasing goods and/or services with the interaction and transaction all effected online. Of course, the advent of an online presence of many businesses significantly improved the accessibility of goods and services provided by organisations to individuals and consumers who would otherwise have experienced significant difficulty obtaining access to the goods and/or services of various organisations.

More recently, mobile phones have developed and transitioned from a device that was primarily intended to conduct voice communications to a device that effectively operated as a personal computer in a form factor similar to a mobile phone handset. Eventually, as mobile phones transitioned to devices that could provide similar functionality as compared with a PC workstation or laptop, they increasingly became known as “smart phones” and at the present time, the use of a smart phone is generally dedicated to executing applications rather than enabling an individual to conduct voice communications with another party or parties.

Not unexpectedly, the combination of a widely accessible data communications network and the availability of smart phones at a cost acceptable to most consumers, most individuals and consumers now own a smart phone and operate that device to perform many daily functions that assist the individual and/or consumer to perform a range of functions including navigating their way to a destination, keeping up to date with developments including the news and weather, conducting searches of websites for research and purchasing goods and/or services and maintaining contact and communication with friends and family.

More recently, individuals and consumers have been encouraged to share their information with other individuals and consumers with the availability of social media Apps. These Apps encourage individuals to share information with other individuals including the publication of images and the sharing of thoughts and opinions with other individuals with whom an individual may form a group or otherwise elect to share their information.

Over time, applications that involve the sharing of personal information have increased in popularity such that they have become ubiquitous and in some instances, smart phones are now provided to consumers with applications pre-loaded ready for configuration and execution upon purchase of a new smart phone. In most instances, applications do not charge a fee for the services provided but generate revenue by receiving payment from media organisations who advertise goods and/or services of businesses seeking to target individuals who use online applications.

Whilst web-sites operated by businesses for the purpose of offering goods and/or services have collected information regarding the searching habits and purchases of individuals for quite some time, the development of other applications and the decision to leverage the information obtained from individuals for sale to sizeable organisations has increasingly caused alarm on the part of many individuals and/or consumers who were previously unaware that their personal information was being used for the purposes of generating revenue for organisations that operate online systems.

Whilst advertising agencies have always sought to persuade and manipulate consumers to encourage behaviour resulting in the consumption of goods and/or services of the businesses who employ the advertising agency, the extent to which advertising agencies could persuade and manipulate consumers was limited by the information they had acquired with respect to consumers, and the level of detail of that information, to determine or postulate the best methods to persuade and manipulate consumers. However, now that consumers are conducting many more interactions and transactions by use of their smart phones across data communication networks with businesses operating online systems, the amount of information obtainable by organisations with respect to consumers who engage with businesses or services in their online presence is significant and provides organisations with a much greater ability to exploit that information for the purpose of persuading and manipulating consumers.

In this regard, possibly one of the most problematic aspects of targeting an individual consumer with information to persuade and manipulate the behaviour of that consumer that has become apparent in recent times is the purposeful selection of news and media that is provided to an individual to provide them with a view of external events that is designed to manipulate and motivate consumers to behave according to the intention of the entity who selects and provides news to the individual through an online service.

Accordingly, now that individuals and consumers understand that organisations are analysing the personal information obtained by those organisations to develop psychological profiles of consumers to improve the prospects of persuading and manipulating behaviour of individuals, consumers are increasingly seeking to limit the amount and type of data about themselves that is divulged to online organisations such as operators of web-sites for the purchase of goods and/or services and operators of other services such as social media and video/audio streaming services.

Of course, it is difficult to maintain privacy with respect to personal data and control the extent of the knowledge and use of that information whilst continuing to use online services and make use of the benefits of same. A further problem associated with attempting to maintain anonymity, or at least limiting the extent to which personal information is divulged to online platforms, is the requirement for consumers to establish an anonymous payment means to enable the purchase of goods and/or services by use of a payment means that does not require the consumer to divulge personal information such as would occur if using a credit card or a direct bank account transfer.

Clearly, individuals and consumers are now aware that the provision of personal information to providers of online services is problematic regarding the personal information they provide and the monitoring of their online activity and presently available techniques to reduce divulging personal information requires substantial time and effort. Therefore, there is a clear need for a system method for anonymising online interactions and transactions that provide individuals and consumers with the ability to engage and interact and/or transact with online platforms without divulging personal and private information and avoiding the monitoring of their online activity that may be subsequently used for a purpose that is not permitted or authorised by the particular individual and/or consumer.

### SUMMARY OF THE INVENTION

In one aspect, the present invention provides a hosting system that hosts a plurality of computer executable applications wherein the applications are accessible by a plurality of users registered to use the hosted plurality of applications, the hosting system including a user access module enabling individual users to access the hosting system using personal credentials and upon entering valid personal credentials, users are assigned one or more system personas for use when the user executes a hosted application, where the details of the system persona are used in place of the user's personal details when the hosted application accesses any online service external to the hosting system, a purchasing facility enabling registered users to purchase goods and/or services online with funds managed by the hosting system, the users utilising a system persona when accessing external online services and the hosting system effecting financial transactions for and on behalf of registered users thereby retaining the privacy of user's personal details within the hosting system and avoiding divulging user's personal details to any online system external to the hosting system.

In a preferred embodiment, the hosted computer executable applications enables access to a range of online services such as access to video and audio streaming services, news and media streaming services and a range of information services such as those provided by statutory or regulatory authorities including taxation departments and/or political organisations. In one embodiment, the hosting system provides a media streaming service that collects news, information and other media from a diverse range of external sources and provides that service to users of the hosting system who may access the collated media streaming service using an assigned system persona. In this way, by obtaining news, information and other media from a range of external sources, the hosting system effects this task for and on behalf of users so that the providers of the news, information and media services are prevented from analysing the items of news, information and media selected for viewing by an individual user and using that information to create a profile of the user for the purpose of exploiting and/or manipulating, that user. Since the hosting system acts as an intermediary in this configuration to provide a hosted online media service, with users accessing that service with an assigned system persona, there is no ability for the provider of the news, information or other media to determine which user of the hosting system accessed which item of news, information or other media. This arrangement is particularly convenient and helpful to users who prefer to avoid providing information regarding their choice of news, information or other media from online service providers who may either exploit that information themselves or provide that information to a third party who aggregates data for the purpose of determining a profile for a user of online services. Of course, the same configuration may be applied to services other than news, information and media services.

The hosted computer executable applications may also include a range of services that adapt, or “plug in”, to existing external online services such as those provided by Google, Pinterest and news services such as news.com such that the hosted computer executable application or plug in enables a user to access these external services by use of an assigned persona provided by the hosting system. In an embodiment, the adaptor or “plug in” executable application may be installed on the user's device and automatically change the internet protocol (IP) address and delete cookies (or any other identifying digital artefact that could be collected or recorded by an external service provider) thereby preventing automated online data collection pertaining to the user's activities when engaging with the external online service. In this embodiment, the persona used by a user is the IP address which is changed automatically each instance of access by the user. In other embodiments, a range of additional or alternative, techniques may be implemented to prevent, or reduce, the ability of a visited external site/service to obtain data from the visitor.

In an embodiment, assigned system personas may also be utilised by users when engaging with services offered by the hosting system for which communication will only occur internally in respect of the hosting system. In this regard, whilst the system persona is automatically utilised to protect a user's identity when accessing external online services, users may also prefer to utilise an assigned system persona for internal online services which may include communications with other users of the hosting system.

In one particular embodiment, the use of a system persona may be controlled by users registered with the hosting system such that users may control the extent to which their assigned system persona is used during access of online services external to the hosting system. In this regard, there are clear benefits associated with allowing the provider of an external online service to develop a profile regarding the individual consumer who accesses their online platform for the purpose of interacting and/or conducting a transaction. One example of an online service for which consumers would likely prefer the organisation operating the service to retain a profile of their activity is online shopping services for groceries. In this regard, in the event that a new system persona were assigned to a registered user of the hosting system each and every time they access an online service to arrange the purchase and delivery of grocery items, the service provider would not be able to access information pertaining to the user's previous purchases and hence, the grocery service would be prevented from providing additional useful information to the consumer such as notifying the user that items regularly purchased in the past are now discontinued with a recommendation regarding a replacement product that the consumer may determine to be a useful alternative.

Accordingly, users may prefer to access a particular external online service with the same assigned system persona each time such that the organisation operating the external online service may develop a profile regarding the preferences of the consumer associated with the system persona. However, at least by use of a system assigned persona, the consumer avoids providing the external online service provider with their personal details which prevents organisations who aggregate data across numerous platforms to develop a detailed profile of individuals who access online services.

Of course, another aspect of current eCommerce transactions that requires consumers to divulge personal address details is the requirement to provide a delivery address when ordering goods online. The following embodiments are illustrations regarding how the hosting provider may facilitate the delivery of goods as an intermediary receiver to avoid divulging the individual's personal details to the online goods provider. In one embodiment, when ordering goods online for delivery to the user, the delivery address associated with the system persona is associated with the address of a warehousing facility operated by the system provider such that any organisation delivering to the warehouse facility is unaware of the eventual recipient of the goods and hence, unaware of any personal and private details relating to the recipient of the goods including their address. In this embodiment, a different collection and delivery agent collects items from the warehouse facility and delivers the item to the preferred delivery address. The details of the delivery address may be obtained by associating the system persona used to order the goods with the system user in respect of whom the system provider retains a physical address. In another embodiment, rather than a warehousing facility, the system provider may utilise publicly assessable lock boxes in respect of which the goods provider places goods in a publicly assessable lock box and locks the box with a locking device that requires a code to release the locking mechanism. Either the system provider, or the intended recipient, may receive the unique code that enables the lock box to be opened thereby enabling collection of the goods when convenient and preserving privacy regarding any information relating to the purchases. In another embodiment, a “click and collect” arrangement may be selected and implemented since such an arrangement clearly does not involve disclosure of personal and/or confidential details regarding the purchaser of the goods apart from the preferred delivery address which may be the residential address of the purchaser. In any event, the separation of information between the goods supplier and the purchaser of the goods, including prevention of provision of all information to separate collection and delivery agents such as a courier, ensures that manufacturers, retailers and suppliers cannot associate purchased goods with the purchaser which prevents the ability to develop a purchasing profile for the purchaser. A “click and collect” arrangement involves a user arranging the purchase of an item through the use of a system persona and receiving a proof of purchase that is supplied by the supplier for the purpose of collection. The user may receive the proof of purchase from the hosting system which has assisted the private purchase and the user may use the proof of purchase to collect the goods from the supplier since provision of the proof of purchase is all that is required to collect the goods. In yet another embodiment, the user may select a “click and deliver” option wherein the hosting system provides a courier with only the details regarding the purchased goods, the collection address and the preferred delivery address. Such an arrangement avoids intermediate handling of the purchased goods and should result in a prompt delivery as compared with other embodiments whilst still preserving the private and confidential details of the purchaser apart from the preferred delivery address. As will be appreciated by skilled readers, the above-described arrangements are also useful in instances where a user purchases goods online for delivery to an intended gift recipient with the arrangement also protecting dissemination of details regarding the gift recipient whose address details are solely provided to the hosting system provider to arrange anonymous receipt of the goods and subsequent delivery to the physical address of the intended recipient.

In an embodiment, one of the services provided by the hosting system includes an electronic mail facility wherein electronic mail addresses are associated with their system persona although visually they may not resemble each other and are used for the purpose of sending and receiving email correspondence. As will be appreciated, in a large number of instances in which online goods are arranged for purchase and delivery, the goods provider will require an electronic mail address to provide information relating to the purchased goods. This may include warranty information, delivery information, delivery timing information, information relating to service and repair facilities etc. In these instances, the user may utilise the hosting system electronic mail facility associated with the assigned system persona for the provision of an electronic mail address for the online goods provider to provide messages to, and receive messages from, the user along with the system persona for the allocation of saved details for the purchase of online goods. Accordingly, in this particular embodiment, the assigned system persona for the user to utilise for the purpose of purchasing online goods may be retained for the purpose of an electronic mail facility until such time as the transaction is completed and the user has received the goods and all information associated with those goods including warranty and service/repair information. In the event the online goods provider seeks to utilise the electronic mail messaging facility to provide additional information to the user, the only details that the online goods provider retains regarding the purchase is an electronic mail address linked to the user's system assigned persona. Of course, any assigned electronic mail address linked to the persona for the purpose of sending and receiving electronic mail messages may have a limited period of validity selectable by the user such that the user is able to choose whether or not to receive on-going information from the online goods provider. In the event the user prefers to continue to receive on-going information, the user may retain the validity of the electronic mail address with the assigned persona for a lengthy period of time. Alternatively, in other instances, a user may deactivate, or block receipt of correspondence from specific entities to the electronic mail address according to the assigned persona shortly after receiving the goods and any information associated with same.

In a preferred embodiment, users are provided with the ability to configure their own electronic mail address linked to their assigned persona for the purpose of utilising that particular online hosted service. In another embodiment, users are assigned a series of online personas which may be selected for particular hosted services or, particular transactions, such that the user may vary the use of their assigned system personas as they prefer.

In the above described embodiment that enables individual users to control the extent to which their system assigned persona is utilised for access to external online services, there may other instances in which the user prefers a unique assigned system persona to be used each and every time they access a particular external online service. In this regard, whilst users may prefer that an online grocery supply service develop a profile regarding their preferences, when accessing services that provide news and current events, individual users may prefer that such online service providers are prevented from developing any profile, or understanding regarding any preferences of the individual accessing the service, which could otherwise be used to determine a range of private and personal information such as political orientation, religious affiliations, sexual preferences and/or any other private and confidential information that is sometimes protected by law.

One aspect relating to online transactions that sometimes requires users to provide details that clearly identify the user and/or provide information to the online goods and/or service provider, is the requirement for a user to provide credit card or debit card details when confirming a purchase. In view of this aspect regarding online transactions, alternative arrangements have become popular whereby users may use an account for the purpose of transferring funds to confirm a purchase whereby the user transfers funds into a transaction account from a deposit account owned by the user with the funds in the transaction account utilized to complete the purchase of online goods and/or services.

In an embodiment of the present invention, the purchasing facility includes a hosting system provided account that is associated with the user that may be accessed by the user for the purpose of purchasing online goods and/or services whilst interacting with online goods and/or service providers and whilst using the users assigned system persona. In this embodiment, the hosting system automatically monitors the system persona assigned to the user for a particular online transaction and in the event the user elects to make a purchase, the hosting system associates the purchase with the assigned system persona and the purchasing facility that is maintained and monitored for, and on behalf of, the user for the purpose of effecting online transactions. In the event insufficient funds are available to the user to effect an online transaction, the hosting system may automatically prompt the user to transfer additional funds to the hosting system purchasing facility without the online goods and/or service provider ever being aware of the communication between the hosting system and the user regarding the funds available to the user for the purpose of effecting a transaction with the online goods and/or service provider. Of course, this arrangement is particularly convenient for users since they may commence a transaction without any knowledge regarding the status of their purchasing facility but may have confidence that in the event insufficient funds are available, the hosting system will prompt the user to provide further funds, possibly by credit card transfer or direct bank transfer, thereby allowing the online transaction according to the user's assigned persona to be completed. In this embodiment, the user's bank account or credit/debit card statements solely reflect transactions with the hosting system and it is only the hosting system transaction account, in the name of a system persona, that reflects the actual purchase of goods or services for and on behalf of the user.

In another aspect, the present invention provides a method for conducting online transactions using a hosting system that hosts a plurality of computer executable applications when the applications are accessible by a plurality of users registered to use the hosted plurality of applications, the computer executable applications including at least an internet browser, the method including a user accessing a user access module that enables individual users to access the hosting system using personal credentials and upon entering valid personal credentials, the user is assigned a system persona for use when the user executes a hosted application, the user accessing a hosted application to access an online service external to the hosting system, the hosting system utilising the assigned system persona for the user for the purpose of the online service thereby anonymizing the details of the user from the online service external to the hosting system, the user accessing a purchasing facility operated by the hosting system instances where the user seeks to access funds to purchase goods and/or services online, the user completing a financial transaction with the online service external to the hosting system utilising funds from the purchasing facility thereby completing a transaction with the online service external to the hosting system whilst retaining the privacy of the user's personal details by avoiding the divulgence of those details to the online system external to the hosting system.

In another aspect, the present invention provides a computer-readable medium having a plurality of instructions executable by one or more processors of a hosting system that hosts a plurality of computer executable applications accessible by a plurality of users to provide a user access to the hosting system using personal credentials and upon receiving valid personal credentials from the user, assigning the user a system persona for use when the user executes a hosted application, provide the user access to a hosted application to access an online service external to the hosting system, utilise the assigned system persona for the user for the purpose of the online service thereby anonymizing the details of the user from the online service external to the hosting system, provide the user access to a purchasing facility operated by the hosting system, and in instances where the user seeks to access funds to purchase goods and/or services online, enable the user to complete a financial transaction with the online service external to the hosting system by utilising funds from the purchasing facility whilst retaining the privacy of the user's personal details by avoiding the divulgence of those details to the online system external to the hosting system.

### BRIEF DESCRIPTION OF THE DRAWINGS

Features of the present disclosure are illustrated by way of example and not limited in the following figure(s), in which like numerals indicate like elements, in which:

FIG. 1 illustrates an exemplary computer-implemented system and method of anonymising online interactions and transactions in accordance with the present invention.

FIG. 2 illustrates an exemplary flow diagram associated with the server component of the system illustrated in FIG. 2.

FIG. 3 illustrates an exemplary flow diagram of a process that enables a user to download and install a software application, plugins and subsequently login, or register, to use the software application for interacting with the system illustrated in FIG. 1.

FIG. 4 illustrates an exemplary flow diagram of a process that enables the user to anonymously conduct online shopping including browsing and purchasing goods and/or services.

FIG. 5 illustrates an exemplary flow diagram of a process that enables the anonymous delivery of goods and/or services purchased by the user.

FIG. 6 illustrates an exemplary flow diagram of a process that enables the user to anonymously view content and streaming services.

### DETAILED DESCRIPTION OF EMBODIMENT(S) OF THE INVENTION

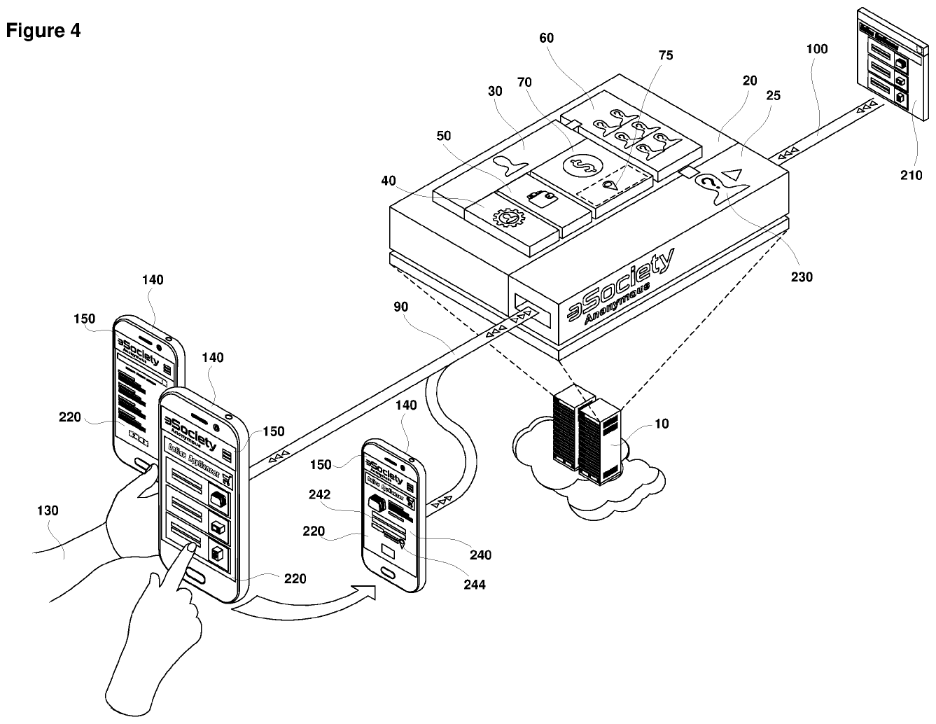

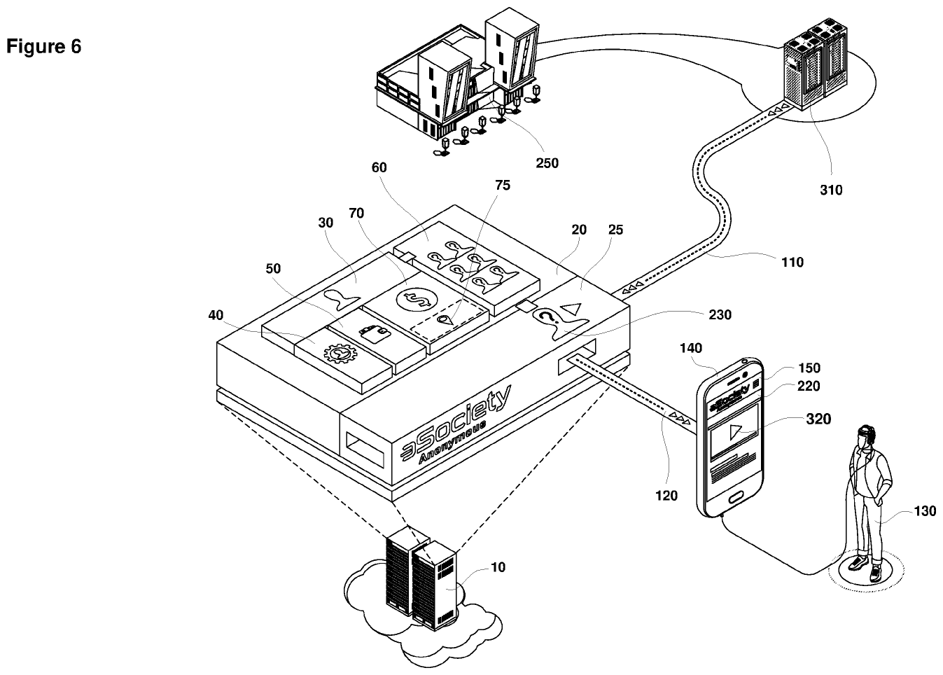

The present invention relates to at least a computer-implemented system and method of providing a hosting system that hosts a plurality of computer executable applications wherein the applications are accessible by a plurality of users (130) registered to use the hosted plurality of applications. In particular, the hosting system includes a user access module (25) that enables individual users (130) to access the hosting system using personal credentials and upon entering valid personal credentials, users (130) are assigned one or more system personas (60) from a plurality of personas for use when the user (130) executes a hosted application, where the details of one of the selected system personas (60) are used in place of the users personal details when the hosting application accesses any online service external to the hosting system. Examples of hosted applications that are executable by the user (130) include an application which allows access to an online shopping service as shown in FIG. 4, and an application which allows access to an online content and streaming service as shown in FIG. 6.

Whilst not shown in the Figures, the hosted computer executable applications may also include a range of services that adapt, or “plug in”, to existing external online services such as those provided by Google, Pinterest and news services such as news.com such that the hosted computer executable application enables a user to access these external services by use of the assigned persona (230) provided by the hosting system. In an embodiment, the adaptor or “plug in” executable application automatically changes the internet protocol (IP) address and also deletes cookies, or any other identifying digital artefact, thereby preventing automated online data collection pertaining to a user's activities when engaging with an external online service. In this embodiment, the IP address represents the assigned persona. In other embodiments, a range of additional or alternative techniques may be implemented to prevent, or reduce, the ability of a visited external site/service to obtain data from the user or track the user. (130).

The system further provides a purchasing facility (70) enabling registered users to purchase goods and/or services online with funds managed by the hosting system. In this way, a user (130) utilising one of the available system personas (60) and using the selected persona (250) when accessing external online services may retain the privacy of their personal details with the hosting system effecting financial transactions for and on behalf of a registered user thereby avoiding divulging user's personal details to any online system external to the hosting system.

Accordingly, the system and method described herein provides a method for users to access online systems, such as online shopping platforms for the purpose of purchasing goods and/or services, without revealing their identity to the online service provider. By remaining anonymous, users' personal information and online activity is prevented from being captured and potential utilised for purposes in respect of which the user would not otherwise authorise, including marketing, product development and consumer behaviour analysis. Additionally, by retaining their anonymity, the personal data of users cannot be on-sold and/or used by other third parties in a manner that the user would not otherwise approve.

The steps described above and throughout the present specification may be performed by using a central server (20) which maintains one or more processors and data bases for performing the one or more actions described, wherein the server (20) may be configured for communication with one or more user devices (e.g. user device (140) upon which a dedicated software application (150) is operable).

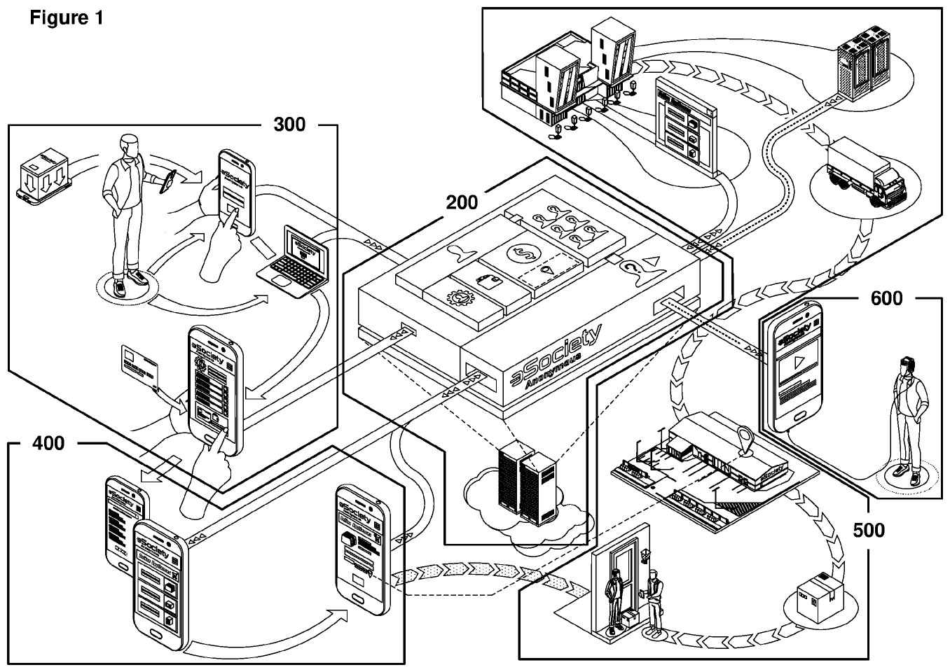

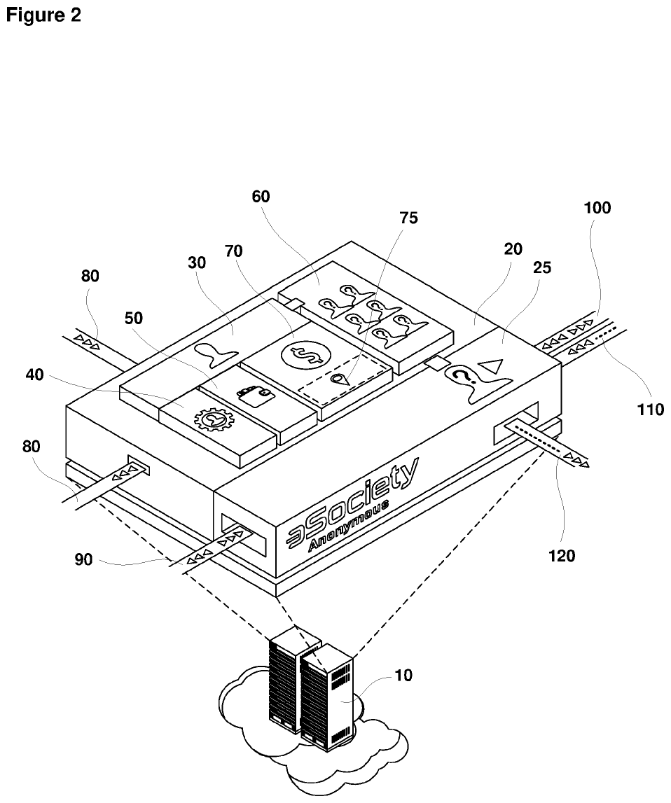

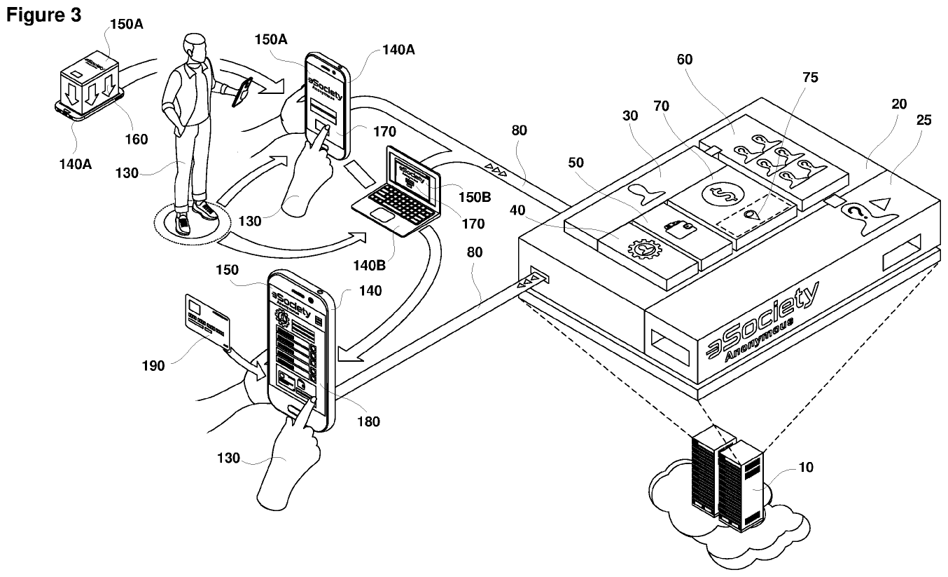

FIG. 1 is divided into segments which are further expanded in the subsequent FIGS. 2 to 5. In particular, segment 200 of FIG. 1 shows the server component (20) with which the software application (150) may operate on a portable device such as a mobile phone (140A), or on a computer such as a desk top computer or laptop (140B) with which interaction is made possible by use of a web browser. FIG. 3 shows examples of both a mobile phone and web browser in use, with applications (150A) and (150B) operating respectively. As an alternative, or in addition to, steps performed by the user device (140), steps may also be performed by one or more processors associated with the server (20) as described further herein. According to a particular implementation, the server (20) may be programmed to provide the functions that are preferably provided by the server rather than locally on the user device.

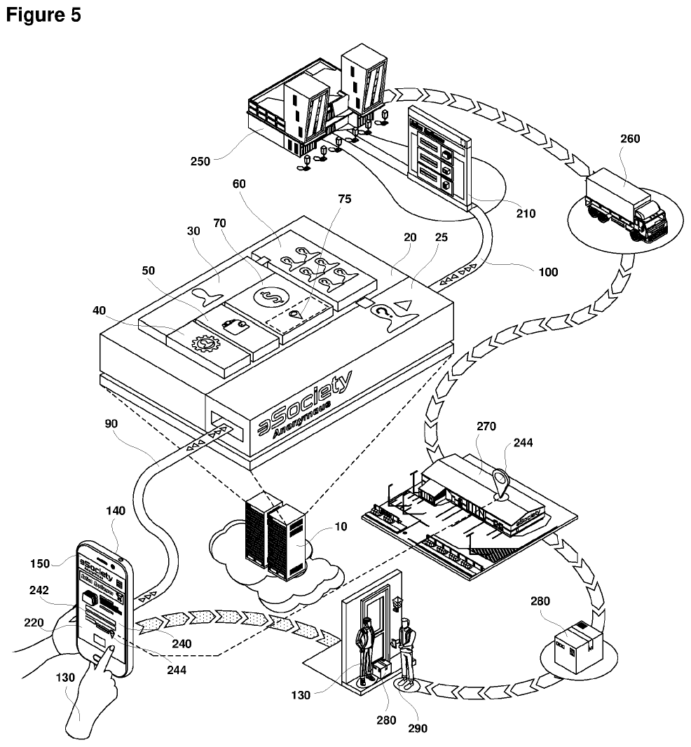

Segment 300 of FIG. 1 shows the user (130) downloading an installing the application (150) and subsequently logging into the application (150), which is expanded in FIG. 3. Segment 400 of FIG. 1 shows the user (130) anonymously browsing an online shopping service and initiating a purchase, which is expanded in FIG. 4. Segment 500 of FIG. 1 illustrates an example of how goods may be shipped or distributed that continues to ensure the user's personal information, including their address, remains anonymous, as expanded in FIG. 5. Finally, segment 600 of FIG. 1 shows an example of how user (130) may anonymously access online content and streaming services utilising the present invention, which is expanded in FIG. 6.

As mentioned above, FIG. 2 shows segment 200 from FIG. 1. In particular, FIG. 2 shows the server component (20) which includes infrastructure (10) upon which the platform of the present invention operates. The infrastructure (20) may be local or cloud-based. The central server (20) may operate one or more computer applications, or provide plug ins or links to relevant executable codes and maintain one or more databases that enable the following functionality and/or storage:
user access module (25) which, as described above, enables the assignment of one or more system personas to the user for use when the user (130) executes a hosted application or plugin, thereby acting as an intermediary between the user (130) and the websites they are accessing. As described in greater detail below, depending upon the user's desired anonymity settings and the websites they are visiting, the persona is either a newly selected persona from a plurality of personas (60), or is a persona that has been previously used so that previously selected preferences and other saved information may be retained. The type of information that may be kept private includes the user's location, their type of browser and the IP address of the device being used to access the online service;
register (30) of user accounts relating to users such as user (130) including for example the user's name, location, age and contact information;
anonymity settings database (40) which stores information relating to the level of anonymity that the user (130) prefers to use either across all hosted applications with respect to all online services, or with respect to individual online services including particular websites;
purchasing facility (50) which enables registered users to purchase goods and/or services online with funds managed by the hosting system, including the management of an account that is linked to an existing bank account associated with the user (130), or an independent bank account that is established and managed by the hosting system at the request of the user (130) that may be linked to any existing use bank or credit account;
persona database (60) storing details relating to personas that are available for assignment to particular individuals in place of their personal information when interacting online. A user (130) may have multiple personas that are available for assignment to the user such that a different persona may be used on different websites depending upon the user's anonymity settings (40);
purchases/subscriptions database (70) storing information relating to purchases of goods and/or services made whilst the user (130) is assigned a particular persona, including for example, goods and/or services purchased, purchase prices, the service provider details relating to the purchase, and any related information that may be useful to store by the hosting system, e.g. for the purpose of providing reports to users regarding their purchasing activity;
deliveries database (75) which stores information relating to the delivery of goods according to purchases (75) including information relating to the particular warehouse or other publicly accessible facility that may be utilised for the purpose of receiving purchased goods on behalf of the user thus ensuring that the user's address remains anonymous.

It is to be understood that despite the existence of multiple databases described above, this is by way of example only and it is to be understood that other arrangements and configurations are possible, e.g. all data could be stored in a suitably indexed data structure.

FIG. 2 also shows that the server (20) is configured to enable general communication (80) with the software application (150) operating on user device (140) by use of a data communications network such as the internet, or similar network. Such communication will enable, for example, users to access user account information (30), anonymity settings (40), purchasing facility details (50), persona information (60), purchase/subscription information (70) and delivery details (75). The user access module (25) associated with the server (20) may enable a virtual or remote browser to be used by the user to anonymously access online services, and the server (20) may be further configured to enable the following additional communication:
communication (90) between the software application and/or plug in (150) operating on user device (140) with the user access module for anonymous remote browsing (25);
communication (100) between the anonymous remote browser associated with the user access module (25) and websites of online retailers of goods and/or services;
communication (110) between the anonymous remote browser associated with the user access module (25) with streaming services; and
streaming (120) of audio and/or video content such as Stan, or Netflix that as registered user may engage with by use of one of the system personas (60).

The above additional communications are described in greater detail with reference to FIGS. 4 to 6 below.

FIG. 3 shows mobile device (140A), and in the alternative computer device (140B), operated by the user (130) to install the respective applications (150A, 150B), which may be achieved by downloading the relevant application from an Application store or a plugin from the platform. A user (130) may create an account using the application (150) and the accounting information may be stored in the user account register (30). The user account may capture information sufficient to enable the user to be correctly and/or legally identified and may include finger print or face recognition data to access the application on smart devices thereby validating the registered user (130).

The processor installing each of the applications is indicated by arrows (160), and an example interface which enables the user (130) to login or register to use the application is indicated by reference (170). Whether using a mobile device or computer device, users (130) will need to login using their login details, or register as a new user, and registration will require user information such as name, location and date of birth and may also require driver's license and passport details to legally identify the user and establish the user's age which may be required for purchase such as alcohol. At this point, the user (130) may also enter details relating to their financial account (190) which they prefer to link to the purchasing facility (150), if applicable, details of which will be stored for future use when making purchases. Such financial account information may include credit card details, debit card details or any other bank account related information to enable such functionality.

FIG. 4 shows an example of an online retailer website (210) accessible, through utilisation of the user access module (25), to users (130) having already installed the plugin for anonymity to access the online retainer website directly.

FIG. 4 shows an anonymised website search using a third party platform (220) in which the user proceeds with a purchase (240) of goods and/or services presented in the online retailer website (210), in which the user (130) will enter their system persona and initiate payment by the hosting system managing purchasing facility (50) such that payment is made by the hosting system on behalf of the user (130). Depending upon the status of the purchasing facility (50), i.e. whether the purchasing facility (50) is an account that is linked to an existing account associated with the user's financial institution, or is an independent account operated by the hosting system on behalf of the user, the hosting system will then debit the relevant account to cover the purchase price incurred on behalf of the user (130). The particular interface shown in FIG. 4 also illustrates the purchase details (242) along with the delivery details (244) confirming the delivery address, which may be an address that is different to the user's actual address depending upon the particular anonymity settings of the user (i.e. whether the user allows their address to be used, or whether the user has selected an alternate delivery address, as described in greater detail below with reference to FIG. 5).

With reference to the purchasing facility (50), the skilled reader will appreciate that the purchasing facility (50) includes a hosting system provided account that is associated with the user (130) that may be accessed by the user (130) for the purpose of purchasing online goods and/or services whilst interacting with online goods and/or service providers and whilst using the user's assigned system persona from the one or more available system personas (60). The hosting system provided account may be in the form of a transaction account that enables the user (130) to provide funds, e.g. by credit card transfer or direct bank transfer, thereby allowing the transaction account to be used to complete a purchase, or in the form of an account that is established and hosted by the hosting system without any requirement to link the account established by the system to an existing account associated with the user (130). For example, the hosting system may issue a bank account and credit card to the user for the purpose of enabling the user to engage in financial transactions utilising the issued bank account and/or credit card whilst using the user's assigned system persona.

In either of the two scenarios described above, there may be circumstances in which the account has insufficient funds. In the event that insufficient funds are available to effect a transaction, the hosting system may prompt the user (130) to transfer manually, or automatically transfer, additional funds to the relevant linked account without the online goods and/or service retailer being aware of the communication between the hosting system and the user (130) in this regard. This arrangement may be particularly convenient for users since they may commence a transaction without any knowledge regarding the status of their purchasing facility but may have confidence that in the event insufficient funds are available, the hosting system will prompt the user (130) to provide, or automatically transfer, further funds based on previously selected preferences (either into their linked account, or directly into the hosted transaction account), thereby allow the online transaction according to the user's assigned persona to be completed.

Following the commitment to purchase goods (280), as shown in FIG. 4, the goods (280) require transport to the user (130) and FIG. 5 illustrates an example of how goods (280) may be transported in a manner that ensures that the retailer never ascertains who purchased the goods (280), including details such as the user's home address. The requirement to provide a delivery address when ordering goods (280) online represents another aspect of current eCommerce transactions that require consumers to divulge personal details. However, as shown in FIG. 5, when the user (130) orders goods (280) from an online retailer (250), the selection of one of the available personas (60) such as persona (25) and use of persona (230) ensures that the delivery address is the address of an intermediary facility (270) operated by the system provider such that any organisation delivering (260) to the intermediary facility (270) is unaware of the address of the eventual recipient of the goods (280) and hence, personal and private details relating to the recipient of the goods (280).

In the embodiment shown, courier collections may be arranged from the intermediary facility (270) for delivery to the intended recipient (130). The details of the delivery address may be obtained by associating the system persona (230) used to order the goods (280) with the user (130) in respect of whom the system provider retains a physical address. As will be appreciated by skilled readers, the above described arrangement is also useful in instances where the user (130) purchases goods online for delivery to an intended gift recipient with the arrangement also protecting dissemination of details regarding the gift recipient whose address details are solely provided to the hosting system to arrange anonymous receipt of the goods and subsequent delivery to the physical address of the intended recipient.

FIG. 5 shows the courier reaching its destination location (290) which will be an address specified by the user (130), at which point the user (130) receives the purchased goods (280). The user could also pick up the goods from the intermediary facility (270).

As previously mentioned, the online services to which the users (130) may gain access after being assigned one or more system personas (60) for use when the user executes the hosted application, are not limited to the online purchase of goods and/or services that may also relate to a range of additional online services. For example, the hosted applications may include a range of online services such as access to video and audio streaming services, news and media streaming services and a range of information services such as those provided by statutory or regulatory authorities including taxation departments and/or political organisations. The example shown in FIG. 6 relates to the delivery of online content and streaming services (320) from a plurality of streaming service providers (310) to the user (130).

By obtaining news, information and other media from a range of external sources such as streaming service providers outside the hosted system (310), the hosting system effects this task for and on behalf of users so that the providers of the news, information and media services are prevented from analysing any personal information including IP address, location, previous search requests submitted by of the user (130) and using that information to, for example, create a profile of the user (130) for the purpose of exploiting and/or manipulating that user.

In one embodiment the hosting system acts as an intermediary to provide access to an online media service (320), with users accessing that service with an assigned system persona (230), thereby avoiding any ability for the provider of the news, information or other media to determine which user of the hosting system accessed which item of news, information or other media. This arrangement is particularly convenient and helpful to users who prefer to avoid providing information regarding their choices to online service providers who may either exploit that information themselves or provide the information to a third party who may, for example, aggregate data for the purpose of determining a profile for the user (130). Of course, the same arrangement may be applied to services other than news, information and media services. In one embodiment access to existing online services may be provided by the hosting system in the form of a plugin that provides the user (130) with access to the online service with the ability to delete details regarding their online access including details of any searches the deletion facility including but not limited to IP addresses and cookies.

One of the preferences that may be specified by a user upon registration and/or subsequent login relates to the extent to which a user prefers to retain their personal details private by use a system persona. In this regard, the use of a system persona may be controlled by the user (130) such that the user (130) may control the extent to which their assigned persona (230) is used during access of online services external to the hosting system. In this regard, there may be clear benefits associated with allowing the provider of an external online service to develop a profile regarding the user (130) for the purpose of interacting and/or conducting transactions. One example of an online service for which the user (130) may prefer the organisation operating the service to retain a profile of their activity is online shopping services for groceries. In this regard, in the event that a new system persona were assigned to the user each and every time they access an online service to arrange the purchase and delivery of groceries items, the service provider would not be able to access information pertaining to the user's previous purchases and hence, the grocery service provider would be prevented from providing additional useful information to the user (130) such as notifying the user (130) that items regularly purchased in the past are now discontinued with a recommendation regarding a replacement product that the user (130) may consider to be a useful alternative. In any event, the extent to which a user prefers to remain anonymous to an online service provider may be controlled by the user. In some instances, a user may prefer to reveal their identity and details to particular online service providers.

The user (130) may prefer to access a particular external online service with the same assigned system persona each time such that the organisation operating the external online service may develop a profile regarding the preferences of the user (130). However, at least by use of a system assigned persona, the user (130) avoids providing the external service provider with their personal details which prevents organisations who aggregate data across numerous platforms to develop a detailed profile of individuals as a result of them accessing online services.

There may be other instances in which the user (130) prefers a unique assigned system persona to be used each and every time they access a particular external online service. For example, whilst the user (130) may prefer that an online grocery supplier service develop a profile regarding their preferences, the user may prefer that in respect of other instances that provide news and current events, such online service providers are prevented from developing any profile, or understanding regarding any preferences of the user (130) which could otherwise be used to determine a range of private and personal information such as political orientation, religious affiliations, sexual preferences and/or any other private and confidential information that is sometimes protected by law.

An additional service provided by the hosting system may include an electronic mail (also known as email) facility wherein users may utilise their system persona for the purpose of sending and receiving email correspondence. As will be appreciated, in a large number of instances in which online goods are arranged for purchase and delivery, the online retailer (250) will require an email address to provide information relating to the purchased goods (280). This may include warranty information, delivery information, delivery timing information, information relating to service and repair facilities, etc. In these instances, the user (130) may utilise the hosting system email facility, thereby using the assigned system persona for the purchase of online goods and the provision of the linked email address for the online retailer (250) to provide messages to, and receive messages from, the user (130).

Accordingly, in this particular embodiment, the assigned system persona for the user (130) to utilise for the purpose of purchasing online goods (280) may be retained for the purpose of an email facility until such time as the transaction is completed and the user (130) has received the goods (280) and all information associated with those goods including warranty and service/repair information. In the event the online retailer (250) seeks to utilise the email messaging facility to provide additional information to the user (130), the only details that the online retailer (250) retains regarding the purchase is an email address based upon the user's system assigned persona (230). Of course, any assigned persona for the purpose of sending and receiving email messages may have a limited period of validity selectable by the user (130) such that the user (130) is able to choose whether or not to receive ongoing information from the online retailer (250). In the event that the user (130) prefers to continue to receive ongoing information, the user (130) may retain validity of the email address with the assigned persona for a lengthy period of time. Alternatively, in other instances, the user (130) may deactivate, or block receipt of correspondence from specific entities to the email address according to the assigned persona shortly after receiving the goods (280) and any information associated with same. The user (130) may use a “friends” list to control receipt of email correspondence from others to the email address associated with the system persona.

The user (130) may also be provided with the ability to configure their own email address according to their assigned persona for the purpose of utilising that particular online hosted service. In an embodiment, the user (130) is assigned a series of online personas which may be selected for particular hosted services or, particular transactions, such that the user (130) may vary the use of their assigned system personas (60) as they prefer.

In a yet further embodiment, assigned system personas may also be utilised by the user (130) when engaging with services offered by the hosting system for which communication will only occur internally in respect of the hosting system. In this regard, whilst the system persona is automatically utilised to protect a user's identity when accessing external online services and applications, the user (130) may also prefer to utilise an assigned system persona for internal online services and applications which may include communications with other users of the hosting system.

It is to be understood that the user device (140) could be a tablet computer, a smartphone, a laptop computer, a desktop computer, or another type of computing device. The user device (140) may include a display that provides an interface for the user to input and/or view information. For example, a user could interact with the device using a program executed on a laptop computer, such as a text-based chat program, a voice-based communication program, and/or a video-based communication program. Alternatively, in some cases, the user device (140) could be a telephone (e.g., a landline, cell phone, etc.)

The central server (20) may be a single computer, the partial computing resources of a single computer, a plurality of computers communicating with one another, or a network of remote servers (e.g., cloud). The one or more servers (20) can house local databases and/or communicate with one or more external databases.

The user device (140) may communicate with the server (20) over a network. In some embodiments, the network may be a wide area network (“WAN”), e.g., the Internet. In other embodiments, the network may be a local area network (“LAN”). For example, in a more remote location far from a metropolitan area, the Internet may not be available. In yet other embodiments, the network may be a combination of a WAN and a LAN. In embodiments where the user device (140) is a phone (e.g., a landline or a cell phone), the communication may pass through a telecommunications network and/or a wide area network.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A hosting system that hosts a plurality of computer executable applications wherein the applications are accessible by a plurality of users registered to use the hosted plurality of computer executable applications, the hosting system including:
a user access module enabling a user to access the hosting system using personal credentials and upon entering valid personal credentials of a user device associated with the user, the user assigned more than one separate system persona for use when the user executes one or more hosted applications, where only the system personas are used in place of the user's personal details when the hosted application accesses an online service external to the hosting system;
a purchasing facility enabling the user to purchase goods and/or services online with the use of their user device with funds managed by the hosting system;
the user restricted to utilising an assigned system persona when accessing any external online service via a hosted application and the hosting system effecting financial transactions for and on behalf of the user thereby ensuring the privacy of the user's personal details within the hosting system and in the event of a user purchasing goods from a service online that is external to the hosting system and requiring physical delivery, the user receiving those goods through a collection and delivery arrangement that includes at least one intermediary exchange wherein the user's preferred delivery address is with-held from transfer between parties involved in the intermediary exchange thereby preventing divulging the user's personal details to any online service external to the hosting system and/or any goods provider and their delivery agents.

2. A hosting system according to claim 1, further including one or more processors in communication with an adaptor executable application installed on the device associated with the user, the adaptor executable application configured to automatically change the internet protocol (IP) address and regularly delete any identifying digital artefact that could be collected or recorded by an external service provider to thereby prevent automated online data collection pertaining to the user's activities when engaging with the external online service.

3. A hosting system according to either claim 1 or claim 2, wherein the assigned system persona used by the user is the IP address which is changed automatically in each instance of access to the hosting system by the user.

4. A hosting system according to any one of the preceding claims, wherein the user further utilises an assigned system persona when accessing internal online services provided by the hosting system.

5. A hosting system according to any one of the preceding claims, wherein the user is able to select which assigned system persona is used during access to external or internal online services thereby enabling the user to control the development of a user profile with respect to individual assigned system personas.

6. A hosting system according to any one of the preceding claims, wherein a delivery address associated with a system persona is associated with an address of a warehousing facility operated by the hosting system such that any organisation delivering to the warehouse facility is unaware of the address details of the user.

7. A hosting system according to any one of the preceding claims, the hosting system further including an electronic mail facility wherein an electronic mail address is associated with a user's system persona, and wherein the electronic mail address and the system persona are visually distinct and used for the purpose of sending and receiving email correspondence.

8. A hosting system according to any one of the preceding claims, wherein the user is able to vary the use of their assigned system personas according to preference with the hosting system automatically monitoring the system persona assigned to the user for a particular transaction and in the event the user elects to make a purchase, the hosting system associating the purchase with the assigned system persona.

9. A hosting system according to any one of the preceding claims, wherein in the event insufficient funds are available to the user to effect a transaction, the hosting system automatically generates and sends a prompt to the user device associated with the user requesting transfer of additional funds to the hosting system purchasing facility.

10. A hosting system according to any one of the preceding claims wherein, in the event of a user purchasing goods from a service online that is external to the hosting system, the user receives the goods according to a delivery arrangement including collection of the goods from the supplier by a first collection/delivery agent and transport of same to one or more intermediary exchange locations, the goods subsequently received/collected by a second collection/delivery agent from the final intermediary exchange location with instructions to deliver the goods to the final delivery address with each collection/delivery agent receiving instructions solely identifying the next destination for each collection/delivery, the user's personal details thereby maintained private and confidential throughout the transportation and delivery of goods with the supplier, and delivery collection/delivery agents delivering to intermediary exchange locations unaware at all times of the final delivery address and each collection agent solely knowledgeable of the next delivery location.

11. A hosting system according to claim 10, wherein the system persona responsible for a purchase of goods is encoded with a non-human readable code displayed on the packaging of the goods and upon scanning the code, each delivery agent is solely provided with the next destination which includes one or more intermediary exchange locations until the goods are eventually delivered to the user's private residence with the final delivery address the only information regarding the user that is provided and only to the final delivery agent.

12. A method for conducting online transactions using a hosting system that hosts a plurality of computer executable applications when the applications are accessible by a plurality of users registered to use the hosted plurality of applications, the computer executable applications including at least an internet browser, the method including:
a user accessing a user access module that enables individual users to access the hosting system using personal credentials and upon entering valid personal credentials, the user is assigned a series of system personas for use when the user executes one or more hosted applications;
the user accessing a hosted application to access an online service external to the hosting system;
the hosting system restricted to utilising an assigned system persona for the user for the purpose of the online service thereby anonymizing the details of the user from the online service external to the hosting system;
the user accessing a purchasing facility operated by the hosting system and in instances where the user seeks to access funds to purchase goods and/or services online, the user completing a financial transaction with the online service external to the hosting system utilising funds from the purchasing facility thereby completing a transaction with the online service external to the hosting system whilst retaining the privacy of the user's personal details and in the event of a user purchasing goods from a service online that is external to the hosting system and requiring physical delivery, the user receiving those goods through a collection and delivery arrangement that includes at least one intermediary exchange wherein the user's preferred delivery address is withheld from transfer between parties involved in the intermediary exchange thereby avoiding the divulgence of those details to the online service external to the hosting system and/or any goods provider and their delivery agents.

13. A method according to claim 12, further including automatically changing, by the use of one or more processors of the hosting system in communication with an adaptor executable application installed on a device associated with the user, the internet protocol (IP) address and regularly deleting any identifying digital artefact that could be collected or recorded by an external service provider to thereby prevent automated online data collection pertaining to the user's activities when engaging with the external online service.

14. A method according to either claim 12 or claim 13, wherein the assigned system persona used by the user is the IP address which is changed automatically upon each instance of access to the hosting system by the user.

15. A method according to any one of claims 12 to 14, further including the user controlling the extent to which the assigned system persona is used during access to external or internal online services thereby enabling the user to control the development of a user profile in respect of individual assigned system personas.

16. A method according to any one of claims 12 to 15, further including sending and receiving email correspondence using an electronic mail facility, wherein an electronic mail address is associated with the user's system persona and wherein the electronic mail address and the system persona are visually distinct.

17. A method according to any one of claims 12 to 16 wherein the series of online personas are selectable for use with particular hosted services and/or, particular transactions, such that the user is able to vary the use of their assigned system personas according to preference with the hosting system automatically monitoring the system persona assigned to the user for a particular transaction and in the event the user elects to make a purchase, the hosting system associating the purchase with the assigned system persona.

18. A method according to any one of claims 12 to 17, wherein in the event insufficient funds are available to the user to effect a transaction, the hosting system automatically generates and sends a prompt to the user device associated with the user requesting transfer of additional funds to the hosting system purchasing facility.

19. A non-transitory computer-readable medium having a plurality of computer instructions executable by one or more processors of a hosting system that hosts a plurality of computer executable applications accessible by a plurality of users to:
provide a user access to the hosting system using personal credentials and upon receiving valid personal credentials from the user, assigning the user a series of system personas for use when the user executes one or more hosted applications;
provide the user access to a hosted application to access an online service external to the hosting system;
utilise an assigned system persona for the user for the purpose of the online service thereby anonymizing the details of the user from the online service external to the hosting system;
provide the user access to a purchasing facility operated by the hosting system; and
in instances where the user seeks to access funds to purchase goods and/or services online, enable the user to complete a financial transaction with the online service external to the hosting system by utilising funds from the purchasing facility whilst retaining the privacy of the user's personal details and in the event of a user purchasing goods from a service online that is external to the hosting system and requiring physical delivery, the user receiving those goods through a collection and delivery arrangement that includes at least one intermediary exchange wherein the user's preferred delivery address is with-held from transfer between parties involved in the intermediary exchange thereby avoiding the divulgence of those details to the online service external to the hosting system and/or any goods provider and their delivery agents.

20. A computer readable medium according to claim 19, further causing the one or more processors to:
automatically change, when in communication with an adaptor executable application installed on a device associated the user, the internet protocol (IP) address and deleting any identifying digital artefact that could be collected or recorded by an external service provider to thereby prevent automated online data collection pertaining to the user's activities when engaging with the external online service.
